(19) United States
(12) Patent Application Publication
(10) Pub. No.: US 2019/0281864 A1
(43) Pub. Date: Sep. 19, 2019

(54) PROCESSING OF PERENNIAL RYE GRASS (LOLIUM PERENNE) FOR HUMAN CONSUMPTION

(71) Applicant: Joel Steven Goldberg, Hillsborough, NC (US)

(72) Inventor: Joel Steven Goldberg, Hillsborough, NC (US)

(21) Appl. No.: 16/431,497

(22) Filed: Jun. 4, 2019

(51) Int. Cl. A23L 2/04; A23L 2/72; A23L 5/20

(52) U.S. Cl. CPC A23L 2/04; A23V 2002/00; A23L 5/23; A23L 2/72

(57) ABSTRACT

Treatment of dried perennial ryegrass with aqueous citrate ion from sodium citrate chelates calcium from the grass which improves extracting juice from the grass. Addition of ascorbic acid to the aqueous solution decreases enzymatic browning of the juice. The juice is centrifuged and filtered. Microscopic examination of the centrifuged and filtered juice that has been stained with methylene blue demonstrates a cellulose content less than extracted wheat grass. Processing the dried perennial ryegrass can be achieved without electricity. Extraction of nutrients from perennial ryegrass may help alleviate world food shortages and may promote peace.

### CROSS-REFERENCES TO RELATED APPLICATIONS

US 2016/0270425 A1

### FEDERALLY FUNDED RESEARCH

None

### BACKGROUND OF THE INVENTION

Severe worldwide food shortages are predicted in sub-Saharan Africa and South Asia by the year 2050. Perennial ryegrass (Lolium perenne) could be an important food source because it is easily adapted to many regions and climates, and it does not need to be replanted every year unlike rice, wheat, or corn.

Harvesting perennial ryegrass in the form of hay is centuries old, and it has the advantage of being a relatively safe, low cost method to store grass protein that is later fed directly to ruminants or converted into silage. Hay can be stored for long periods in a dry environment and processed for food as the need arises. Storing grass proteins in liquid has many disadvantages including cost and contamination.

Previously, it was shown that dried perennial ryegrass treated with an aqueous solution of sodium citrate or sodium citrate buffer could be then manually juiced or extracted. Dried perennial ryegrass that was treated only with water could not be juiced with a manual extraction device. The extract contained approximately 20% crude protein per one hundred gram dry weight and all essential amino acids for human sustenance. (Goldberg, 2016) It was postulated that citrate ions chelated calcium, weakened the cellulose structure by disrupting pectin bonds, and thus the grass could be manually juiced.

Previous work teaches that soluble edible protein from green crops such as alfalfa can be successfully isolated through extraction, filtration, centrifugation, and subsequent heat treatment or treatment with acid to form a purified denatured cytoplasmic protein. (Bickoff, 1977) These methods extract and waste chloroplastic protein, chlorophyll, carotenoids, and lipids to obtain a clear juice before protein purification. None of these methods have become commercially sustainable.

Extraction of juice from wheat grass with subsequent ingestion of the juice is common and purported to provide many health benefits. Young fresh wheat grass has a low cellulose content, and extraction of the juice is quite easy. Microscopic examination confirms the cellulose content of the extract, and the extracted wheat grass juice can be consumed without serious gastrointestinal side effects. (FIG. 1)

In this invention, it was shown that an aqueous solution of sodium citrate chelates calcium in rehydrated perennial ryegrass hay. The proof of this concept was demonstrated through gross and histologic examination of citrate vs. non-citrate treated grass. Furthermore, in this invention, it was shown that microscopic examination of processed perennial ryegrass contains a cellulose content equal or less than that of processed wheat grass, and therefore should be acceptable for human consumption. (FIGS. 1 and 2)

### DESCRIPTION OF THE DRAWINGS

FIG. 1 is a photomicrograph ×40 of the cellulose in wheat grass extract stained with methylene blue.

FIG. 2 is a photomicrograph ×40 of the cellulose in a centrifuged and filtered extract of perennial ryegrass stained with methylene blue.

### DETAILED DESCRIPTION OF THE INVENTION

In this invention, it was shown that dried perennial ryegrass pretreated with an aqueous solution of sodium citrate that is centrifuged and filtered can yield an extract that has a particulate content significantly less than the extract from fresh wheat grass. Without significant cellulose, this extract can be a fundamental food source for malnourished and starving human populations.

In this invention, it was demonstrated that citrate ions chelated calcium in rehydrated perennial ryegrass hay, significantly improving the efficiency of juicing. This proof of concept was confirmed by staining the ryegrass with a buffered ethanol solution of Eriochrome Black T. The gross and microscopic examination of the non-treated grass stained positive for calcium (purple), compared to the citrate treated grass which did not show a color change and remained (blue-green).

A second method, using trypan blue to demonstrate that citrate ion chelation of calcium disrupted the morphology of the cellular wall of perennial ryegrass was not successful.

Furthermore, it was shown that ascorbic acid added to the sodium citrate solution to lower the pH of the solution to 6-7 decreased enzymatic browning of the extracted juice.

The best embodiment of this invention comprises the following steps:

1. Treat the dried perennial rye grass with an aqueous solution of 0.1M to 1.0 M sodium citrate with added ascorbic acid titrated to a pH of 6-7.

2. Juice the grass with a manually or non-manually powered juicer.

3. Manually or non-manually centrifuge the juice.

4. Filter the juice.

5. Examine the juice in which the cellulose has been stained with 0.1% methylene blue under a 40× microscope.

6. Consume the juice.

### Experimental Section

Experiment #1: Histologic proof of concept that approximately 1.0 M sodium citrate chelates calcium in dried perennial rye grass.

Fifty milligram samples of dried perennial ryegrass were immersed in five ml of well water or five ml of a saturated solution of sodium citrate (approximately 1.0 M) in well water for forty-eight hours. The samples were washed with well water and then immersed in methanol for three days with periodic exchanges of methanol to decolorize the samples by extraction of chlorophyll. The samples were immersed in an ethanol bicarbonate buffered solution of Eriochrome Black T at a pH of 10 for thirty minutes and then examined. Gross examination revealed that the water samples not treated with sodium citrate had stained purple stain for calcium, but the sodium citrate samples remained blue-green demonstrating absence of calcium. The samples were also observed under a 40× light microscope and the water-treated samples were purple while the sodium citrate samples remained blue-green. Since this may be the first report of using Eriochrome Black T as a temporary histologic stain for calcium, the experiment was conducted in quadruplicate with the same outcome.

Of note, use of Eriochrome Black T solution as sensitive temporary stain for calcium may have uses beyond this invention, one instance being as a histologic stain for detection of calcium in early stages of atherosclerosis. (Goldberg, 2011)

Conclusion: Sodium citrate extracts calcium from rehydrated dried perennial rye grass.

Experiment #2: Trypan blue staining of citrate vs. non-citrate treated perennial ryegrass was inconclusive.

Fifty milligram samples of dried perennial ryegrass were immersed for twenty-four hours in well water, 1.0 M sodium citrate, 0.1 M sodium citrate, 1.0 M citric acid, 0.1 M citric acid, and 1.0 M sodium citrate/citric acid buffer at pH 6.0, and 0.1 M sodium citrate/citric acid buffer at pH 6. (Table 1) The specimens were washed multiple times in 70% ethanol to extract the chlorophyll and decolorize. The specimens were mounted on glycerol and observed under a 40× microscope. The presence of intracellular trypan blue was graded on a 1-3 scale with 3 being the most penetrance. (Table 1)

TABLE 1
Trypan blue staining of extracts of rehydrated perennial ryegrass

| | Average |
|---|---|
| Treatment of dried ryegrass | penetrance |
| Well water | 3 |
| 1.0M sodium citrate | 1 |
| 0.1M sodium citrate | 3 |
| 1.0M citric acid | 2 |
| 0.1M citric acid | 2 |
| 1.0M sodium citrate buffer | 1 |
| 0.1M sodium citrate buffer | 3 |

Conclusion: Trypan blue was not a useful stain to distinguish citrate treated from non-citrate treated specimens of rehydrated dried perennial ryegrass.

Experiment #3: Microscopic examination of perennial ryegrass extract vs. wheat grass extract.

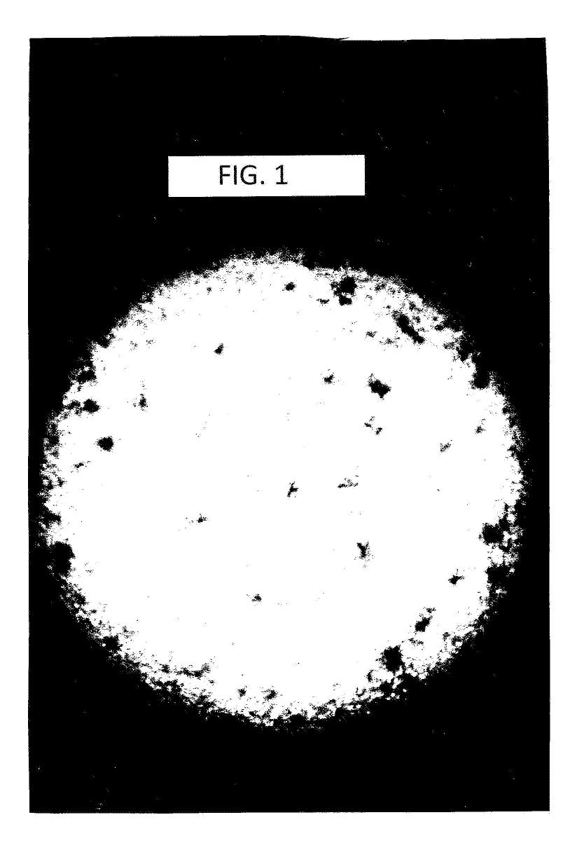

Wheat grass from a local grocer was manually extracted, and the extract was stained for cellulose with 0.1% methylene blue and microscopically examined under 40× (FIG. 1)

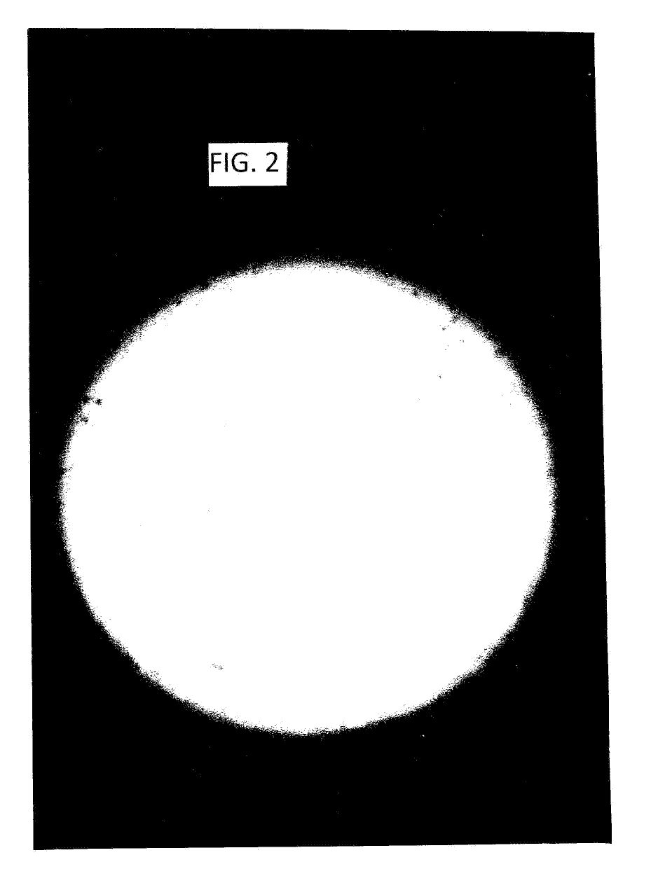

Twenty-five grams of dried perennial ryegrass were treated with two hundred milliliters of 0.5 M sodium citrate buffer with a pH of 5.65. The grass was treated for twenty-four hours and then the grass was washed with water. Juice from the grass was extracted with a manual juicer and fifty milliliters of the juice was centrifuged for five minutes at 1500 rpm (a speed that can be easily achieved with a manual centrifuge). The supernatant was gravity filtered with either a paper or porcelain filter, the filtrate stained with 0.1% methylene blue, and microscopically examined under 40×. (FIG. 2)

Conclusion: Wheat grass extract contained significantly more cellulose than the sodium citrate processed dried perennial ryegrass. The processed perennial ryegrass could be a source of high protein and low cellulose food.

### Benefits to Society

If population growth continues, alternative sources of food will be required to feed humans. Food extracted from dried perennial ryegrass that has been treated with sodium citrate and ascorbic acid can be processed (with or without electricity) and may sustain starving or malnourished populations. Food insecurity is a source of conflict among nations and their constituents. Maybe this invention will promote peace. However, processing dried perennial ryegrass, much like peace negotiations, requires work.

### REFERENCES

Goldberg, J. S., DECALCIFICATION OF PASTURE GRASS FOR FOOD AND FUEL, US 2016/0270425 A1, Published Sep. 22, 2016
Bickoff, E. M., PREPARATION OF SOLUBLE EDIBLE PROTEIN FROM LEAFY GREEN CROPS, U.S. Pat. No. 4,006,078, Published Feb. 1, 1977
Goldberg, Joel Steven (2011). Atherosclerosis: Viewing the problem from a different perspective including possible treatment options. Lipid insights 4. pp. 17-26.

Having described my invention, I claim:

1. A method to process dried perennial ryegrass for human consumption comprising:
a. treating the said dried perennial ryegrass with an aqueous solution of 0.1 M to 1.0 M sodium citrate and added ascorbic acid to achieve a solution of pH of 6-7
b. extracting juice from the said perennial ryegrass
c. centrifuging the extract
d. filtering said extract
e. monitoring the treatment process by microscopic examination.
